(19) United States
(12) Patent Application Publication
(10) Pub. No.: US 2006/0200539 A1
(43) Pub. Date: Sep. 7, 2006

(54) Determining a boot server network address from which to download an operating system during a boot sequence

(76) Inventors: Elizabeth M. Kappler, Hillsboro, OR (US); Mitch A. Williams, Hillsboro, OR (US)

Correspondence Address: KONRAD RAYNES & VICTOR, LLP.;ATTN: INT77, 315 SOUTH BEVERLY DRIVE, SUITE 210, BEVERLY HILLS, CA, 90212, US

(21) Appl. No.: 11/072,850

(22) Filed: Mar. 3, 2005

(51) Int. Cl. G06F 15/177

(52) U.S. Cl. 709/220

(57) ABSTRACT

Provided are a method, system, and program for determining a boot server network address from which to download an operating system during a boot sequence. A request for a network address to use to communicate on a network to a server during a boot sequence is transmitted. An operation is performed to download an operating system from a first type of boot server network address indicated in a response from the server to the request. An operation is selectively performed to download the operating system from a second type of boot server network address in response to determining that the response does not indicate the first type of boot server network address. The downloaded operating system is loaded.

### BACKGROUND

A computer system includes a basic input/output system (BIOS) memory that stores the code for the boot sequence the central processing unit (CPU) executes to power-on and initialize the computer components. Typically, the CPU executing the BIOS code initializes certain hardware components, such as the memory, and then spins-up the hard disk drives. After the hard disk drives are operable, the CPU loads the operating system from a hard disk drive to boot the system.

Current network cards may implement the Preboot Execution Environment (PXE) protocol to download the operating system from a remote server during the boot sequence. During the boot sequence, the network adaptor PXE code requests an Internet Protocol (IP) from a Dynamic Host Configuration Protocol (DHCP) supporting the PXE protocol. The response from the DHCP server includes an IP address and may also include PXE options identifying a network address from which to download the operating system files using the Trivial File Transfer Protocol (TFTP). The network adaptor then downloads the operating system from the TFTP server address identified in the DHCP response. Further details of the PXE protocol are described in the publication “Preboot Execution Environment (PXE) Specification, Version 2.1” (Copyright Intel Corp. 1999).

### BRIEF DESCRIPTION OF THE DRAWINGS

FIG. 1 illustrates an embodiment of a network computing environment.

FIG. 2 illustrates an embodiment of a DHCP response.

FIG. 3 illustrates an embodiment of operations to determine a boot server network address to use to download the operating system.

FIG. 4 illustrates an additional embodiment of operations to determine a boot server network address to use to download the operating system.

FIG. 5 illustrates a still further embodiment of operations to determine a boot server network address to use to download the operating system.

### DETAILED DESCRIPTION

In the following description, reference is made to the accompanying drawings which form a part hereof and which illustrate several embodiments. It is understood that other embodiments may be utilized and structural and operational changes may be made without departing from the scope of the embodiments.

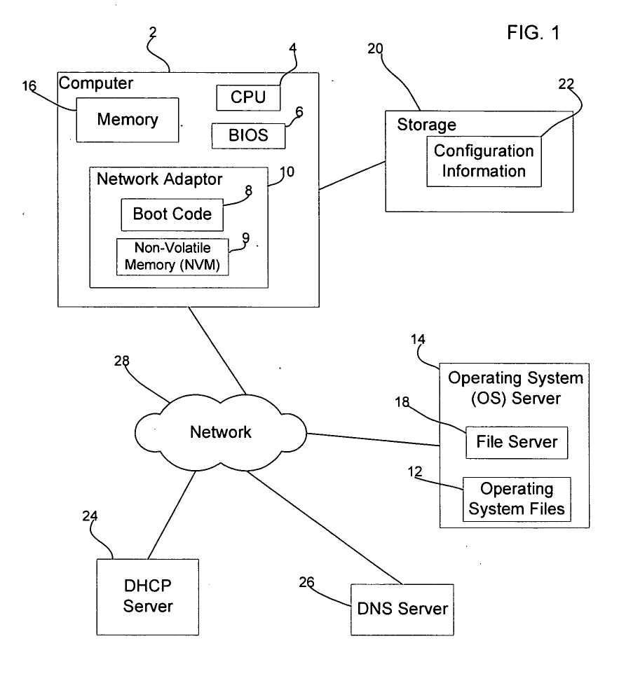

FIG. 1 illustrates a network computing environment used with the described embodiments. A computer 2 includes a processor 4 (such as one or more central processing units (CPU)), a basic input/output system (BIOS) 6 including code executed by the processor 4 to initialize and control various computer 2 components (e.g., the keyboard, display screen, disk drives, serial communications, etc.) during a boot sequence. As part of the boot sequence, boot code 8 in an attached network adaptor 10 is executed by the network adaptor 10 to download operating system files 12 from an operating system (OS) server 14. The network adaptor 10 may include a processor or hardware logic to execute the boot code 8. The operating system is loaded from the downloaded operating system files 12 into a memory 16. The OS server 14 includes a file server 18 that transmits operating system files 12 from computers 2 requesting the operating system files 12. The file server 18 may support a transport protocol, such as Hypertext Transfer Protocol (HTTP) for responding to Universal Resource Locator (URL) requests, a File Transfer Protocol (FTP) or Trivial File Transport Protocol (TFTP) to respond to FTP requests for operating system files 18.

The computer 2 has an attached storage 20 including configuration information 22 that may be used during the boot sequence, such as a domain name from which to retrieve or search for operating system files, a static network (IP) address, etc. In an alternative embodiment, the configuration information 22 including an IP address and boot server network address may be maintained in non-volatile memory 9 (NVM) in the network adaptor 10, such as a flash memory.

The computer 2 communicates with the OS server 14, a Dynamic Host Configuration Protocol (DHCP) server 24, and Domain Name Server (DNS) 26 over a network 28. During the boot sequence, the network adaptor boot code 8 may communicate with the DHCP server 24 to obtain a network address, e.g., an IP address, to use for network communication. The boot code 8 may further submit a domain name to the DNS server 26 to resolve the submitted domain name to a network address, e.g., an IP address, to use to access the OS server 14 to download the operating system files 18. The boot sequence, as implemented in the BIOS 6, which in addition to loading the operating system from the downloaded operating system files 18, also loads application programs and device drivers, e.g., network adaptor, disk drivers, display drivers, etc., into a runtime environment (not shown) implemented in memory 16.

The BIOS 6 may be implemented in firmware in a non-volatile memory device on the computer 2 motherboard, such as a Flash memory, Read Only Memory (ROM), Programmable ROM (PROM), etc. The BIOS 6 code indicates the sequence of the boot operations. The boot code 8 may be implemented within a non-volatile memory device in the adaptor 10, an Application Specific Integrated Circuit (ASIC), etc.

The operating system files 12 may provide the files for an operating system known in the art, such as a Microsoft® Windows® operating system, Linux™, etc. (Microsoft and Windows are registered trademarks of Microsoft Corporation and Linux is a trademark of Linus Torvalds). The network adaptor 10 may be implemented in integrated circuit components on the computer 2 motherboard, such as in a LAN (Local Area Network) on motherboard implementation. Alternatively, the network adaptor 10 may be implemented on an expansion card that may be inserted into an expansion card slot on the computer 2 motherboard.

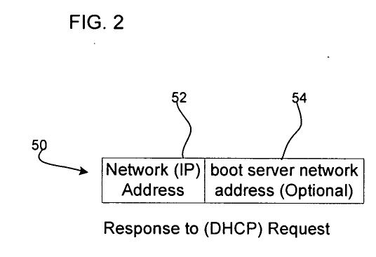

FIG. 2 illustrates information included in a response 50 from a request by the network adaptor boot code 8 to the DHCP server 24 for a network (IP) address, where the response includes the requested network (IP) address 52 and a boot server network address 54 that the boot code 8 uses to locate the OS server. The boot server network address 54 is optional and may not be included in the response 50. Additionally, the response 50 may include the boot file name, a boot server, e.g., URL, and other information.

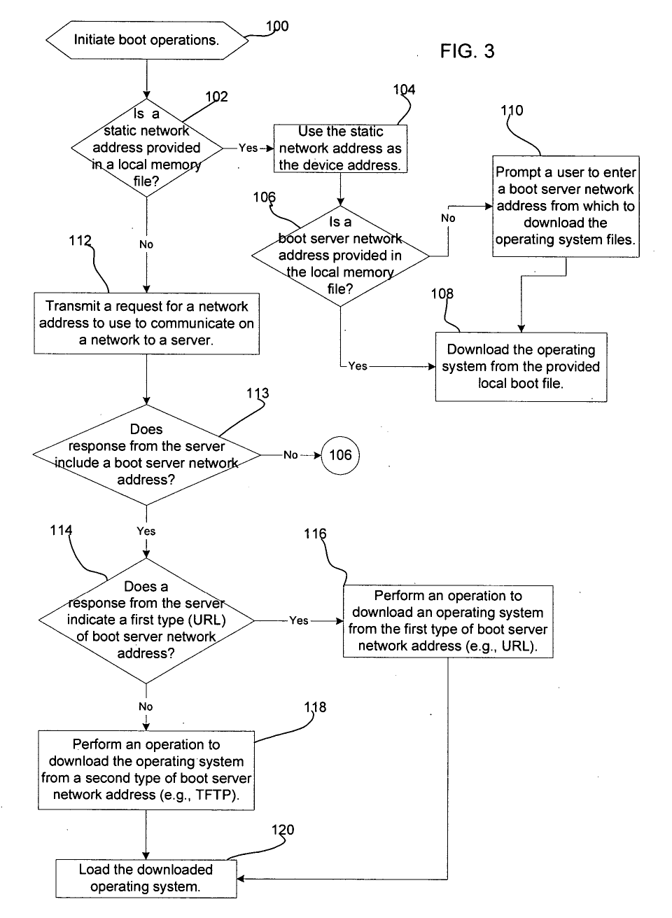

FIG. 3 illustrates an embodiment of operations implemented in the boot code 8 executed by the network adaptor 10. The CPU 4 executes the BIOS 6 to initiate boot operations (at block 100). As part of the boot sequence, the network adaptor 10 executes the boot code 8 to determine (at block 102) whether a static network address is provided in a local memory file, such as the configuration information 22 in the attached storage 20. If (at block 102) the static network (IP) address is provided, then the static network (IP) address is used (at block 104) as the device address of the computer 2. If (at block 106) a boot server network address is also provided in the configuration information 22, which may comprise a URL or TFTP server address, then the boot code 8 downloads (at block 108) the operating system files 12. Otherwise, if (at block 106) a boot server network address is not provided, then the boot code 8 prompts (at block 110) a user to enter a boot server network address from which to download the operating system files 12. The operating system files 12 may then be downloaded from the user entered boot server network address using a file transfer protocol, such as HTTP or TFTP.

If (at block 102) a static network (IP) address was not provided, then the boot code 8 transmits (at block 112) a request for a network (IP) address and boot server network address, such as in the Preboot Execution Environment (PXE) protocol, to a server, such as the DHCP server 24. If (at block 113) a response 50 from the DHCP server 24 includes a boot server network address 54, then control proceeds to block 114; otherwise control proceeds to block 106 to determine static or manual boot server network address information. If (at block 114) a response 50 from the server 24 indicates a first type (e.g., URL) of network address in the boot server network address field 54, then the boot code 8 performs (at block 116) an operation to download the operating system files 12 from the first type of boot server network address (e.g., URL address). Otherwise, if (at block 102) the first type of boot server network address is not provided, but a second type of boot server network address is provided in the configuration information 22, then the executed boot code 8 downloads (at block 120) the operating system from the second type of boot server network address (e.g., TFTP). From block 116 or 118 the downloaded operating system files 12 may then be loaded (at block 120) into memory 14.

With the described operations of FIG. 3, the boot code 8 executed by the network adaptor 10 may be capable of downloading the operating system files using boot server network addresses having different network address protocols, such as an HTTP or TFTP protocol request. In this way, the boot code 8 may use a protocol to access the OS server 14 in a remote network, such as over the Internet, by using the HTTP protocol, whereas the TFTP protocol may be used to access an OS server 14 in a local network.

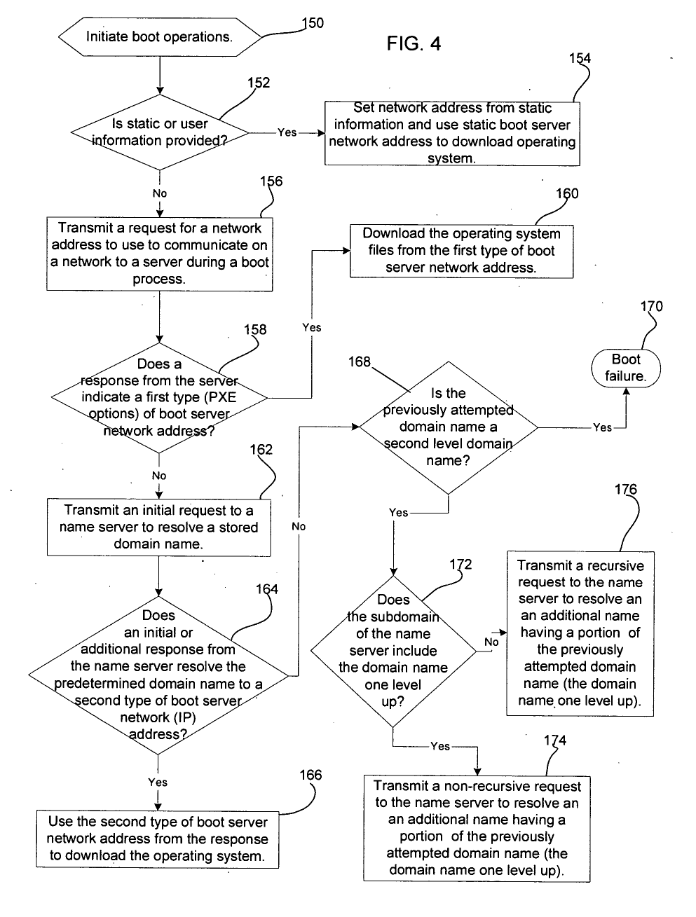

FIG. 4 illustrates an additional embodiment of operations implemented in the boot code 8 executed by the network adaptor 10. The CPU 4 executes the BIOS 6 to initiate boot operations (at block 150). As part of the boot sequence, the BIOS 6 or boot code 8 determines (at block 152) whether a static network address provided, such as in the configuration information 22. If so, then the network (IP) address is set (at block 154) from static information and then used to download the operating system files 12 from a static boot server network address. If (at block 152) a static network address is not provided, then the boot code 8, as executed by the network adaptor 10, transmits (at block 156) a request, e.g., a DHCP request, for a network (IP) address to use to communicate on the network 28 to the DHCP server 24. If (at block 158) the response from the DHCP server 24 indicates a first type of a boot server network address, e.g., a boot server network address 52 indicated in PXE options in the DHCP response 50 (FIG. 2), then the boot code 8 downloads (at block 160) the operating system files 12 from the OS server 14 at the first type of boot server network address, e.g., boot server network address 52 provided with DHCP response 50.

Otherwise, if (at block 158) the response does not indicate a first type of boot server network address, i.e., does not have PXE options, then the boot code 8 transmits (at block 162) an initial request to a name server, e.g., DNS server 26, to resolve a stored domain name. In one embodiment, the boot code 8 may transmit a non-recursive DNS lookup for the stored domain name to the DNS server 26, which may be stored in the configuration information 22. Upon receiving a non-recursive lookup, the DNS server 26 does not attempt to resolve the domain name to an IP network address if the domain name does not lie in the subdomain over which the DNS server 26 is an authority. If (at block 164) the response from the DNS server 26 resolves the predetermined domain name to a second type of network address, e.g., an IP address, then the boot code 8 uses (at block 166) the second type of boot server network address from the response to download the operating system files 12 from the file server 14. In this way, the request from the adaptor 10 to the DNS server 26 does not burden the network 26 because the DNS server 26 does not attempt to recursively search other DNS servers to resolve the domain name. If the response from the DNS server 26 does not resolve the domain name, as indicated in a response from the DNS server 26, then the boot code 8 determines (at block 168) whether the previously attempted domain name is a second level domain name. If so, control ends (at block 170) with a boot failure. Otherwise, if not, then a determination is made (at block 172) as to whether a subdomain of the domain name server 26 includes the domain name one level up. If so, then the boot code 8 transmits (at block 174) a non-recursive request to the name server 26 to resolve an additional name having a portion of the previously attempted domain name (e.g., the domain name one level-up). Otherwise, if (at block 172) the subdomain of the name server 26 does not include the domain name one level up, then the boot code 8 transmits (at block 174) a recursive request to the name server to resolve an additional name having a portion of the previously attempted domain name (the domain name one level up).

For instance, the stored domain name first transmitted in the initial request at block 162 may comprise the domain name (1):
pxeboot.payables.accounting.intel.com (1)

The “.com” portion is the top level domain name, “intel.com” is the second level domain name, “accounting.intel.com” is the third level domain name, “payables.accounting.intel.com” is the fourth level domain name, and “pxeboot” is the machine name. A DNS server 26 used by the computer 2 may have authority over subdomains including the second, third, or fourth level of the domain name (1). For instance, the DNS server for “intel.com” has authority over the second level domain name and all subdomains including “intel.com”, such as the domain name (1). However, a DNS server that only has authority over the domain “engineering.intel.com”, does not have authority over the subdomain including the domain name “accounting.intel.com” domain.

In a non-recursive lookup, such as at block 162 and 174, the DNS server 26 will not attempt to recursively call another DNS server if it cannot resolve the domain name locally, i.e., it does not have authority over the domain including the domain name. In a recursive lookup, the DNS server 26 will call other DNS servers to attempt to resolve a domain name over which the DNS server does not have authority. Further, the first request at block 162 may comprise a non-recursive lookup. In such case, if the DNS server 26 cannot resolve the request locally, i.e., the initially requested domain name is not within the subdomain of the DNS server 26, then the DNS server 26 returns information indicating that the name could not be resolved. The DNS server 26 may also return or be queried to return the domain name over which the DNS server 26 has authority. The boot code 8 may then use this returned information at block 172 to determine whether to send the additional request to resolve the next higher level domain name recursively (at block 176) or non-recursively (at block 174). Further, the boot code 8 may not attempt an additional request to resolve the next higher domain name if the next higher domain name is the top level domain, i.e., the previously attempted domain name is the second level domain name. This ensures that the PXE boot file is included in a specific domain, e.g., intel.com, and not just the general “.com” domain from which a malicious file could be downloaded.

With the operations of the embodiment of FIG. 4, the boot code 8 may attempt to automatically locate the OS server 14 starting from a stored domain name that is likely to enable access to the OS server 14a if the DHCP request does not include PXE options having a boot server network address.

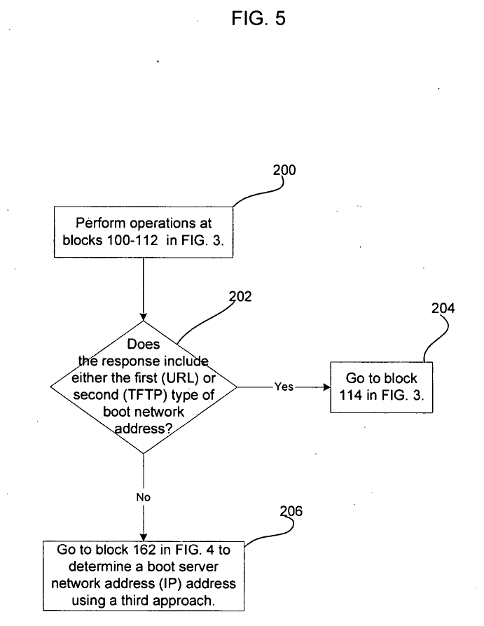

FIG. 5 illustrates an embodiment of operations combining operations of FIGS. 3 and 4. Control begins (at block 200) with the boot code 8 performing operations 100 through 112 in FIG. 3 to use static information or transmit a request to the DHCP server 24 to obtain a network (IP) address and boot server network address. If (at block 202) the response includes either the first (e.g., URL) or second (e.g., TTFP) type of boot server network address, then control proceeds (at block 204) to block 114 in FIG. 3 to download the operating system from the boot server network address in either of the two protocols, e.g., HTTP and TTFP. Otherwise, if (at block 202) the response does not include a boot server network address of the first type (e.g., URL) or second type (e.g., TTFP), then control proceeds (at block 206) to block 162 in FIG. 4 to determine a boot server network (IP) address by using a third approach involving a DNS lookup, such as a non-recursive and/or recursive DNS lookup, as opposed to the first (URL) or second (TFTP) boot server network address.

Described embodiments provide a technique to allow a network adaptor during the boot sequence to determine a boot server network address from which to download operating system files, where different types of boot server network addresses (e.g., network address in different protocols) may be used and determined by the network adaptor.

### Additional Embodiment Details

The described embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, a wireless transmission media, optical cable, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the embodiments, and that the article of manufacture may comprise any information bearing medium known in the art.

The described operations may be performed by circuitry, where “circuitry” refers to either hardware or software or a combination thereof. The circuitry for performing the operations of the described embodiments may comprise a hardware device, such as an integrated circuit chip, Programmable Gate Array (PGA), Application Specific Integrated Circuit (ASIC), etc. The circuitry may also comprise a processor component, such as an integrated circuit, and code in a computer readable medium, such as memory, wherein the code is executed by the processor to perform the operations of the described embodiments.

In one embodiment, the boot operations to download the operating system files 12 are performed by boot code 8 in the network adaptor 10. In an alternative embodiment, the boot code 8 may comprise part of the BIOS 6.

In one embodiment, the DHCP server 24, DNS server 26, and OS server 14 may each be implemented on a separate system in the network 28. Alternatively, any of the components 24, 26, and 14 may be combined in a same system on the network.

In the described embodiments, the boot code 8 requests a non-recursive DNS lookup from the DNS server 26. In an alternative embodiment, the boot code 8 may request a recursive DNS lookup.

The illustrated operations of FIGS. 3, 4, and 5 shows certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit the embodiments to the precise form disclosed. Many modifications and variations are possible in light of the above teaching.

What is claimed is:

1. A method, comprising:
transmitting a request for a network address to use to communicate on a network to a server during a boot sequence;
performing an operation to download an operating system from a first type of boot server network address indicated in a response from the server to the request;
selectively performing an operation to download the operating system from a second type of boot server network address in response to determining that the response does not indicate the first type of boot server network address; and
loading the downloaded operating system.

2. The method of claim 1, wherein the first and second types of boot server network addresses indicate the network location in different communication protocols.

3. The method of claim 1, further comprising:
selectively transmitting a request to a name server to resolve a predetermined name in response to determining that the response does not indicate one of the first type and second type of the boot server network addresses;
receiving a third type of network address in a response from the name server; and
performing an operation to use the third type of network address to download the operating system.

4. The method of claim 3, wherein the first type of boot server network address comprises a Universal Resource Locator (URL) address, wherein the second type of boot server network address comprises a Trivial File Transfer Protocol (TFTP) address, and wherein the third type of network address comprises an Internet Protocol (IP) address.

5. The method of claim 1, further comprising:
selectively determining whether a static network address is provided in a local boot file, wherein the request for the network address is transmitted in response to determining that no static network address is provided; and
determining whether the first type or second type of boot server network address is provided in the local boot file, wherein downloading the operating system from the first type or second type of boot server network address is selectively performed in response to determining that the first or second type of boot server network address is provided in the local boot file.

6. The method of claim 5, further comprising:
selectively prompting a user to enter a boot server network address from which to download the operating system in response to determining that the first or second type of boot server network address is not provided in the local boot file.

7. The method of claim 1, further comprising:
selectively transmitting a request to a name server to resolve a name in response to determining that the response does not indicate the first type of boot server network address;
determining whether a response from the name server resolves the name to the second type of boot server network address; and
selectively using the second type of boot server network address from the response to download the operating system in response to determining that the initial response includes the second type of boot server network address.

8. The method of claim 7, wherein the name in the request comprises a stored name, further comprising:
selectively transmitting one additional request to the name server to resolve an additional name having a portion of the name in the transmitted request in response to determining that the name server did not resolve the name;
determining whether an additional response from the name server resolves the additional name to the second type of network address; and
selectively using the second type of network address from the response to download the operating system in response to determining that the additional response includes the second type of network address.

9. The method of claim 8, wherein the name comprises a domain name, and wherein the additional name comprises a domain name one level-up from the name, further comprising:
determining whether the additional name comprises a second level domain name, wherein the additional request is not transmitted in response to determining that the additional name comprises the second level domain name;
determining whether a subdomain of the name server includes the additional name, wherein the additional request comprises a non-recursive request in response to determining that the subdomain includes the additional name, and wherein the additional request comprises a recursive request in response to determining that the subdomain does not include the additional name.

10. The method of claim 1, wherein the first type of network address identifies one machine on a local network and wherein the second type of network address identifies one machine on one machine in a network external to the local network.

11. An apparatus capable of communicating with a network and server over the network, comprising:
logic to execute during a boot sequence of the computer system, wherein the logic is enabled to cause operations to be performed, the operations comprising:
(i) transmitting a request for a network address to use to communicate on the network to the server;
(ii) performing an operation to download an operating system from a first type of boot server network address indicated in a response from the server to the request; and
(iii) selectively performing an operation to download the operating system from a second type of boot server network address in response to determining that the response does not indicate the first type of boot server network address, wherein the computer system loads the downloaded operating system.

12. The apparatus of claim 11, wherein the adaptor is further capable of communicating with a name server over the network, wherein the operations further comprise:
selectively transmitting a request to the name server to resolve a predetermined name in response to determining that the response does not indicate one of the first type and second type of the boot server network addresses;
receiving a third type of network address in a response from the name server; and
performing an operation to use the third type of network address to download the operating system.

13. The apparatus of claim 11, wherein the operations further comprise:
selectively determining whether a static network address is provided in a local boot file, wherein the request for the network address is transmitted in response to determining that no static network address is provided; and
determining whether the first type or second type of boot server network address is provided in the local boot file, wherein downloading the operating system from the first type or second type of boot server network address is selectively performed in response to determining that the first or second type of boot server network address is provided in the local boot file.

14. The apparatus of claim 11, wherein the adaptor is further capable of communicating with a name server over the network, and wherein the operations further comprise:
selectively transmitting a request to the name server to resolve a name in response to determining that the response does not indicate the first type of boot server network address;
determining whether a response from the name server resolves the name to the second type of boot server network address; and
selectively using the second type of boot server network address from the response to download the operating system in response to determining that the initial response includes the second type of boot server network address.

15. The apparatus of claim 14, wherein the name in the request comprises a stored name in the adaptor, wherein the operations further comprise:
selectively transmitting one additional request to the name server to resolve an additional name having a portion of the name in the transmitted request in response to determining that the name server did not resolve the name;
determining whether an additional response from the name server resolves the additional name to the second type of network address; and
selectively using the second type of network address from the response to download the operating system in response to determining that the additional response includes the second type of network address.

16. The apparatus of claim 15, wherein the name comprises a domain name, wherein the additional name comprises a domain name one level-up from the name, and wherein the operations further comprise:
determining whether the additional name comprises a second level domain name, wherein the additional request is not transmitted in response to determining that the additional name comprises the second level domain name;
determining whether a subdomain of the name server includes the additional name, wherein the additional request comprises a non-recursive request in response to determining that the subdomain includes the additional name, and wherein the additional request comprises a recursive request in response to determining that the subdomain does not include the additional name.

17. A system capable of communicating with a network and server over the network, comprising:
a motherboard;
a processor on the motherboard; and
an adaptor on the motherboard enabling communication with the network and server over the network, comprising:
(i) logic to execute during the boot sequence, wherein the logic is enabled to cause operations to be performed, the operations comprising:
(a) transmitting a request for a network address to use to communicate on the network to the server during a boot sequence;
(b) performing an operation to download an operating system from a first type of boot server network address indicated in a response from the server to the request; and
(c) selectively performing an operation to download the operating system from a second type of boot server network address in response to determining that the response does not indicate the first type of boot server network address, wherein the computer system loads the downloaded operating system.

18. The system of claim 17, wherein the adaptor is further capable of communicating with a name server over the network, wherein the operations further comprise:
selectively transmitting a request to the name server to resolve a predetermined name in response to determining that the response does not indicate one of the first type and second type of the boot server network addresses;
receiving a third type of network address in a response from the name server; and
performing an operation to use the third type of network address to download the operating system.

19. An article of manufacture implemented in a computer readable medium including code capable of communicating with a server over a network, wherein the code is capable of causing operations to be performed, the operations comprising:
transmitting a request for a network address to use to communicate on the network to the server during a boot sequence;
performing an operation to download an operating system from a first type of boot server network address indicated in a response from the server to the request;
selectively performing an operation to download the operating system from a second type of boot server network address in response to determining that the response does not indicate the first type of boot server network address; and
loading the downloaded operating system.

20. The article of manufacture of claim 19, wherein the first and second types of boot server network addresses indicate the network location in different communication protocols.

21. The article of manufacture of claim 19, wherein the code is further capable of communication with a name server, wherein the operations further comprise:
selectively transmitting a request to the name server to resolve a predetermined name in response to determining that the response does not indicate one of the first type and second type of the boot server network addresses;
receiving a third type of network address in a response from the name server; and
performing an operation to use the third type of network address to download the operating system.

22. The article of manufacture of claim 21, wherein the first type of boot server network address comprises a Universal Resource Locator (URL) address, wherein the second type of boot server network address comprises a Trivial File Transfer Protocol (TFTP) address, and wherein the third type of network address comprises an Internet Protocol (IP) address.

23. The article of manufacture of claim 19, wherein the operations further comprise:
determining whether a static network address is provided in a local boot file, wherein the request for the network address is selectively transmitted in response to determining that no static network address is provided; and
determining whether the first type or second type of boot server network address is provided in the local boot file, wherein downloading the operating system from the first type or second type of boot server network address is selectively performed in response to determining that the first or second type of boot server network address is provided in the local boot file.

24. The article of manufacture of claim 19, wherein the operations further comprise:
selectively prompting a user to enter a boot server network address from which to download the operating system in response to determining that the first or second type of boot server network address is not provided in the local boot file.

25. The article of manufacture of claim 19, wherein the code is further capable of communication with a name server, and wherein the operations further comprise:
selectively transmitting a request to the name server to resolve a name in response to determining that the response does not indicate the first type of boot server network address;
determining whether a response from the name server resolves the name to the second type of boot server network address; and
selectively using the second type of boot server network address from the response to download the operating system in response to determining that the initial response includes the second type of boot server network address.

26. The article of manufacture of claim 25, wherein the name in the request comprises a stored name, and wherein the operations further comprise:
selectively transmitting one additional request to the name server to resolve an additional name having a portion of the name in the transmitted request in response to determining that the name server did not resolve the name;
determining whether an additional response from the name server resolves the additional name to the second type of network address; and
selectively using the second type of network address from the response to download the operating system in response to determining that the additional response includes the second type of network address.

27. The article of manufacture of claim 26, wherein the name comprises a domain name, and wherein the additional name comprises a domain name one level-up from the name, wherein the operations further comprise:
selectively determining whether the additional name comprises a second level domain name, wherein the additional request is not transmitted in response to determining that the additional name comprises the second level domain name;
determining whether a subdomain of the name server includes the additional name, wherein the additional request comprises a non-recursive request in response to determining that the subdomain includes the additional name, and wherein the additional request comprises a recursive request in response to determining that the subdomain does not include the additional name.

28. The article of manufacture of claim 19, wherein the first type of network address identifies one machine on a local network and wherein the second type of network address identifies one machine on one machine in a network external to the local network.
